(19) United States
(12) Patent Application Publication
(10) Pub. No.: US 2007/0072139 A1
(43) Pub. Date: Mar. 29, 2007

(54) Candle coupler and apparatus

(75) Inventors: William George Xenakis, Pleasanton, CA (US); Gregory George Xenakis, Fremont, CA (US); Suzanne Maria Xenakis, San Jose, CA (US)

Correspondence Address: John Nielsen;RANDICK O''DEA & TOOLIATOS, LLP, 5000 HOPYARD ROAD, SUITE 400, PLEASANTON, CA, 94588, US

(73) Assignee: Kandy Brights, Inc.

(21) Appl. No.: 11/234,485

(22) Filed: Sep. 23, 2005

(51) Int. Cl. F23D 3/16

(52) U.S. Cl. 431/289

(57) ABSTRACT

A candle apparatus having an edible base connected to a candle by means of a coupling device. The invented device is a structure which is constructed from (1) an edible, typically confectionery, base, (2) a coupler to attach the base to a candle, and (3) a candle held to the top of the structure by the means of the coupler. The candle, which is the top component of the structure, may be a traditional wax and wick candle. The coupler, which is the center component of the structure, serves to attach the candle to the edible base. The edible base, which is the bottom component of the structure, may be a candy or chocolate treat.

### BACKGROUND OF THE INVENTION

Patent Application of Gregory George Xenakis, and William George Xenakis, and Suzanne Maria Xenakis for a candle coupler with edible base.

A. Field of the Invention

The present invention relates generally to structure and method of use of birthday or other celebratory candles that allow the celebrants to eat a portion of the candle apparatus, typically a confectionery base.

B. Description of Related Art

Birthday and other celebratory candles have been in use for many years. Typically they are manufactured in various shapes, sizes, and colors, but in most cases they are made entirely of candle wax and a wick that is intended to be ignited and then extinguished in a short period of time.

A problem with wax candles is that, although frosting may be licked from them after they are removed from the cake, they are typically made of inedible wax.

The present invention solves this problem by providing an edible treat that can be eaten (along with the cake icing that sticks to the confectionery base when it is removed from the cake), while also providing a traditional candle that can be lit and blown out.

Another problem with conventional celebratory candles is that they are typically constructed using much more wax and wick than is necessary for the time required to sing the traditional birthday or other celebratory song, and for the celebrant to blow out the candles. Consequently, traditional candles are typically blown out and discarded after they have been only partially used. This invention eliminates waste by enabling a portion of the candle apparatus to be consumed rather than entirely discarded.

In these respects, the present invention substantially departs from the conventional concepts and designs of the prior art, and in so doing provides a product primarily developed to provide an improved type of candle apparatus.

### SUMMARY OF THE INVENTION

In view of the foregoing disadvantages inherent in the known types of candles now present in the existing art, the present invention provides an improved type of candle having an edible confectionery base.

The general purpose of the present invention, which will be described subsequently in greater detail, is to provide a new edible candle apparatus that has the same advantages as the traditional celebratory candle and to provide various novel features that result in a novel candle device.

This invention includes a new type of candle apparatus that is used in a similar manner to the way traditional all-wax candles are used. A significant difference between the way the present invention and traditional wax candles can be used is that traditional wax candles can only have the icing licked from them after they are removed from a cake. This device allows the celebrants to eat the base.

To attain this, the present invention generally comprises:

1) an edible, typically confectionery, base;

2) a coupler to attach the edible base to candle; and

3) a candle held by the coupler.

The candle on the top of the structure may be a traditional wax and wick candle. The coupler is the device that fastens or attaches the candle to the edible confectionery base component. The coupler is the device that serves to connect the candle to the confectionery base. The confectionery base is an edible candy, chocolate, or other confectionery treat.

It is also anticipated that this invention will allow a method of use that allows celebrants to “have their cake and eat the candles too”. An example of this method of use is as follows:

Operation: Example (Birthday Party).

1) The invention is inserted into the top of the cake;

2) the candle on top is ignited;

3) partygoers then traditionally sing the Happy Birthday song;

4) the birthday celebrant traditionally makes a wish;

5) the birthday celebrant extinguishes the flame(s) by blowing on them;

6) after the candles are fully extinguished, the coupler and candle assembly is removed, as a unit, and discarded; and

7) finally, the celebrant and the partygoers eat the confectionery bases.

An objective of the present invention is to provide a candle apparatus that will overcome the shortcomings of the prior art.

An object of the present invention is to provide a candle that has an edible confectionery base. An additional embodiment of the invention is to provide a coupler, located between a candle and an edible base.

Additionally, the invention anticipates a candle and holder assembly comprising:

1) edible, usually confectionery, base(s);

2) coupler(s) to attach the edible base(s) to one or more candles on top; and

3) one or more candles held on by the coupler(s) to the top of the structure.

The candle at the top of the apparatus may be a traditional wax and wick candle that can be ignited and then blown out by the celebrant. The candle may be constructed of any type material that can be ignited and then blown out by a person.

The coupler attaches the candle that is normally on the top of the structure to the edible confectionery base component that is normally on the bottom of the structure. The coupler must firmly hold the candle onto the confectionery base, but it could permit the removal of the base so that the edible base may be eaten. The coupler may be constructed out of any material and may have any shape that will enable the candle to be held firmly onto the confectionery base.

The edible base may be an edible candy or chocolate or other confectionery substance that is enjoyable to eat. The edible base may be constructed in any shape, including, but not limited to that of a rod (to imitate the appearance of a traditional candle), the shape of a number or letter, or in the shape of a fictional or non-fictional character. Examples of non-fictional characters include famous people, or animals. The edible base may also be shaped like any inanimate object or theme (e.g. a tombstone). The base may serve as both: (1) A structure to support the coupler and the candle on top of it; and (2) A structure that is inserted into, or affixed on top of, a cake on its opposite end.

The candle may be inserted into the coupler that holds it firmly in place. The coupler may be attached to the confectionery base in a manner that will be secure during the time the candle is burning, yet may be easily removed after the candle is blown out in order that the base may be eaten by the celebrants. The candle may be inserted into a cavity of the coupler or may be manufactured onto a protrusion from the coupler, or may be attached to the coupler in any way that holds it firmly in place.

The candle is separated from, and attached to, the base by the coupler. One embodiment of the coupler includes a cup shaped device inserted into the top of the coupler. The cup shaped insert may or may not be made of a non-flammable material. This portion of the coupler is capable of receiving and securing the candle. The device will typically be sold with the cup-shaped insert already inserted into the coupler for ease of use. The cup shaped insert is merely an embodiment. It is also anticipated that the entire coupler could be made of a non-flammable material. These embodiments will serve to separate the flame and wax of the candle from the confectionery base.

The base may be held to the coupler in any fashion that will hold it firmly while the candle is burning yet permit simple removal after the candle is extinguished. One implementation of this coupler has dual cavities on top and bottom, separated by an internal partition. Additional embodiments of the coupler may take the form of fictional or non-fictional characters, or numerals. Additional embodiments include those wherein the means for connecting the coupler to the edible base comprises a protrusion for insertion into the edible base. There may be other ways to construct the coupler that would be equal in effect and performance.

While the preferred embodiment for the invention contemplates a single edible base coupled to a single candle, other embodiments include multiple edible bases coupled to a single candle, multiple candles coupled to a single edible base, and multiple candles coupled to multiple edible bases.

In some embodiments, the invention includes a receptacle (or cavity) on the top of the coupler apparatus that is intended to hold the candle in an upright position. The invention includes embodiments where the receptacle is composed of or lined with a non-flammable material or insert. Such a material may be composed of any material which does not easily burn or melt, including metal.

In a related embodiment, a non-flammable cup shaped insert is placed in the candle receptacle. This type of insert could also be made from a variety of materials which do not easily burn or melt, including metal.

There has thus been broadly outlined the more important features of the invention in order that the detailed description thereof may be better understood, and in order that the present contribution to the art may be better appreciated. There are additional features of the invention that will be described hereinafter.

### BRIEF DESCRIPTION OF THE DRAWINGS

FIG. 1 is a perspective view of an apparatus comprising a wax and wick candle, a coupler, a coupler insert, and an edible base constructed in accordance with the present invention.

FIG. 2 is a perspective view of an apparatus comprising a wax and wick candle, a coupler, a coupler insert, and an edible base (in the form of a numeral “1”) constructed in accordance with the present invention.

FIG. 3 is an exploded view of the candle, insert, coupler, and base apparatus shown in FIG. 1.

FIG. 4 is a cross sectional view of the candle, coupler and insert, and edible base constructed in accordance with the present invention.

FIG. 5 is a top down view of the coupler constructed in accordance with the present invention.

FIG. 6 is a cross sectional view of a partial assembly of a candle, coupler and insert, and edible base constructed in accordance with the present invention.

### DETAILED DESCRIPTION OF THE INVENTION

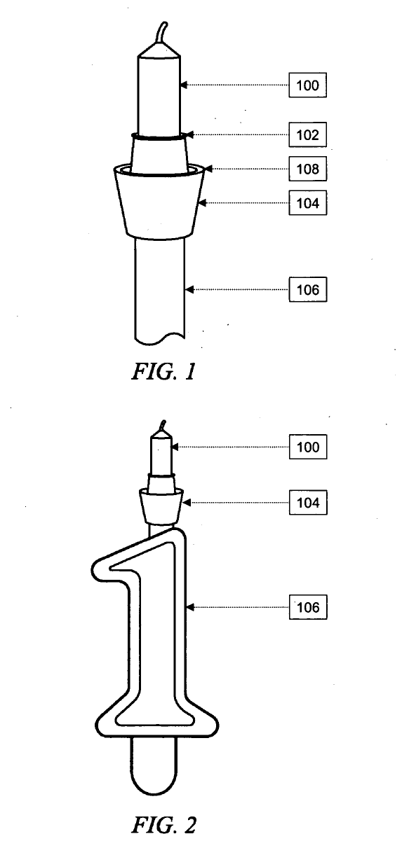

FIG. 1 is a perspective view of a coupler as part of an assembly that includes a wax and wick candle and an edible base constructed in accordance with the present invention. The top of the drawing depicts an example of a standard wax and wick candle 100. The bottom portion of the candle is located in the non flammable insert 102, which in turn is located in the top cavity of the coupler 104. The top of the edible base 106 is positioned in the bottom cavity of the coupler 104. In this embodiment, the coupler 104 is configured to include a rim 108 that rings the exterior of the coupler: The rim 108 may assist in collecting and diverting the melted wax from the candle so as to minimize the amount of wax that comes into contact with the edible base.

FIG. 2 is a perspective view of an assembly that includes a wax and wick candle, a coupler and insert, and an edible base constructed in accordance with the present invention. As in FIG. 1, the top of the drawing depicts an example of a standard wax and wick candle 100, a portion of which has been placed into a non flammable insert 102. The insert 102 is again positioned in the top cavity (or receptacle) of the coupler 104. The edible base 106, in this embodiment, has the form of a numeral “1”. The top of the edible base 106, has been placed into the bottom cavity (or receptacle) of the coupler 104.

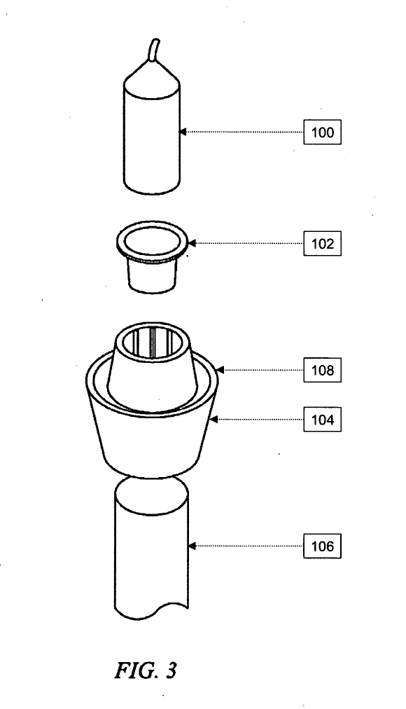

FIG. 3 is an exploded view of the candle 100, insert 102, coupler 104, and base 106 apparatus shown in FIG. 1. The top of the drawing depicts an example of a standard wax and wick candle 100. A coupler insert 102 is depicted below the candle 100. The coupler insert comprises a cavity that is capable of receiving and securing the bottom portion of the candle. The coupler insert shown in this drawing also includes a lip that encircles the top of the cavity. Due to the proximity of flame from the candle, it is anticipated that the coupler insert will generally be made of a non flammable material.

The interior of the coupler is depicted in this embodiment as containing ridges or grooves. Although the ridges or grooves may assist in securing the coupler insert 102 to the coupler 104, they are not a requirement. The coupler 104 depicted in the drawing is of a dual cavity design that allows the candle 100 and coupler insert 102 to be placed in the top cavity, while the top portion of the edible base 106 can be placed into the coupler's bottom cavity.

Also shown is the top portion of an edible base 106. This embodiment of the edible base 106 is in the form of a rod shape.

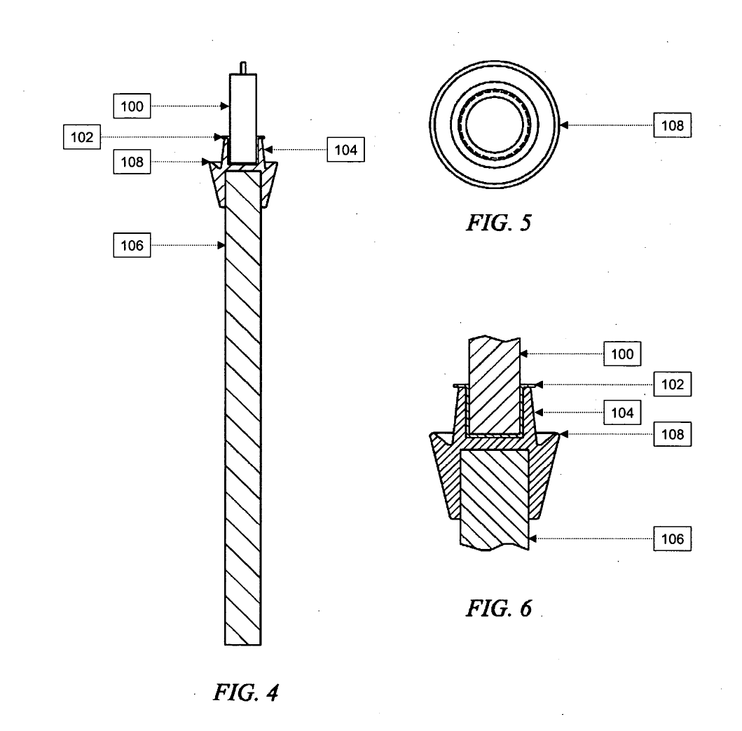

FIG. 4 is a cross sectional view of the candle, coupler, coupler insert, and edible base constructed in accordance with the present invention. The top of the drawing depicts an example of a standard wax and wick candle 100. The bottom portion of the candle 100, as shown, is positioned in the insert 102, which in turn is located in the top cavity of the coupler 104. The drawing detail also shows the coupler's rim 108 located approximately midway down the coupler 104. Again, it is anticipated that the rim 108 may collect melted wax emanating from the candle 100 during use. The top portion of the edible base 106 is positioned in the bottom cavity of the coupler 104. This embodiment of the edible base 106 is in the form of a rod shape.

FIG. 5 is a top down view of the coupler 104 constructed in accordance with the present invention. The top cavity is depicted with an interior circle, while the rim 108 is depicted with an outer circle.

FIG. 6 is a partial cross sectional view of the candle, coupler, coupler insert, and edible base constructed in accordance with the present invention. The top of the drawing depicts an example of the lower portion of a standard wax candle 100. This bottom portion of the candle 100, as shown, is positioned in the insert 102, which in turn is located in the top cavity of the coupler 104. The drawing detail also shows the coupler's rim 108 located approximately mid way down the coupler 104. Again, it is anticipated that the rim 108 may collect melted wax emanating from the candle 100 during use. The top portion of the edible base 106 is positioned in the bottom cavity of the coupler 104.

With respect to the above description then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to these illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Other objectives and advantages of the present invention will become obvious to the reader and it is intended that these objectives and advantages be within the scope of the present invention.

To accomplish the above and related objectives, this invention may be embodied in the form illustrated in the accompanying drawings, attention being called to the fact however, that the drawings are illustrative only, and that changes may be made in the specific construction illustrated.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

What is claimed is:

1. A coupler comprising:
a. a means for holding a candle in an upright position on a first end of the coupler; and
b. a means for connecting the coupler to an edible base on a second end of the coupler.

2. A coupler as in claim 1 wherein the means for holding the candle in an upright position comprises a receptacle opening on the first end.

3. A coupler as in claim 1 wherein the means for connecting the coupler to the edible base comprises a receptacle opening on the second end.

4. A coupler as in claim 2 or 3 wherein the receptacles on the first and second ends are separated by a partition.

5. A coupler as in claim 1, wherein the means for connecting the coupler to the edible base comprises a protrusion for insertion into the edible base.

6. A coupler as in claim 2, further comprising a cup-shaped rim surrounding the exterior surface of the receptacle on the first end.

7. A coupler as in claim 2 or 3, wherein the interior surface(s) of the receptacle(s) on at least one end have longitudinal ridges.

8. A coupler as in claim 2 or 3, wherein the interior surface(s) of the receptacle(s) on at least one end have longitudinal grooves.

9. A coupler as in claim 2 wherein the interior surface of the receptacle opening on the first end is composed of a nonflammable material.

10. A coupler as in claims 2 wherein the interior surface of the receptacle opening on the first end is lined with a nonflammable material.

11. A coupler as in claim 2, further comprising a cup insert located in the receptacle on the first end.

12. A coupler as in claim 2, further comprising a non flammable cup insert located in the receptacle on the first end.

13. A candle and holder assembly comprising:
a. a candle; and
b. a coupler, on which the candle is mounted, that has a first end and a second end; and
1. the coupler has a means for securing the candle in an upright position on the first end of the coupler; and
2. the coupler has a means for securing itself to an edible base on the second end of the coupler; and
c. an edible base capable of being connected to the second end of the coupler.

14. A candle and holder assembly as in claim 13, wherein the means for securing the edible base to the second end of the coupler comprises a receptacle opening on the second end of the coupler.

15. A candle and holder assembly as in claim 13, wherein the means for securing the candle to the first end of the coupler comprises a receptacle opening on the first end of the coupler.

16. A candle and holder assembly as in claim 14 or 15, wherein the receptacles on the first and second ends of the coupler are separated by a partition.

17. A candle and holder assembly as in claim 13, wherein the means for securing the coupler to the edible base comprises a protrusion on the second end of the coupler for insertion into the edible base.

18. A candle and holder assembly as in claim 15, further comprising a cup-shaped insert surrounding the exterior surface of the first end of the receptacle of the coupler.

19. A candle and holder assembly as in claim 15 wherein the interior surface of the receptacle on the first end of the coupler is composed of a non flammable material.

20. A candle and holder assembly as in claim 15 wherein the interior surface of the receptacle opening on the first end of the coupler is lined with a non flammable material.

21. A candle and holder assembly as in claim 15 further comprising a non-flammable cup insert located in the receptacle at the first end of the coupler.

22. A candle and holder assembly as in claim 14 or 15 wherein the interior surface(s) of the receptacle(s) of the coupler on at least one end have longitudinal ridges.

23. A candle and holder assembly as in claim 13, wherein the edible base is shaped as a number.

24. A candle and holder assembly as in claim 13, wherein the edible base is shaped as one or more letters.

25. A candle and holder assembly as in claim 13, wherein the edible base is cylindrically shaped.

26. A candle and holder assembly as in claim 13, wherein the edible base is shaped as a fictional character.

27. A candle and holder assembly as in claim 13, wherein the edible base is shaped as a non-fictional character.

28. A candle and holder assembly as in claim 13, wherein the edible base is shaped as an inanimate object.

29. A candle and holder assembly as in claim 13, further comprising:
a. a plurality of edible bases;
b. a plurality of candles; and
c. a coupler that has the means for attaching the plurality of candles to the plurality of edible bases.

30. A coupler as in claim 1 wherein the coupler is shaped as a fictional character.

31. A coupler as in claim lwherein the coupler is shaped as a numeral.

32. The candle holder assembly as in claim 13, further comprising:
a. a plurality of edible bases;
b. a coupler that has a first end and a second end;
c. a means for a candle to attach to the first end of the coupler;
d. a candle attached to the first end of the coupler; and
e. a means for the ends of each of the edible bases to attach to the second end of the coupler.
